(19) United States
(12) Patent Application Publication
(10) Pub. No.: US 2004/0010457 A1
(43) Pub. Date: Jan. 15, 2004

(54) Instantaneous settlement apparatus

(75) Inventor: Kazumasa Kakuta, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/614,785

(22) Filed: Jul. 9, 2003

Related U.S. Application Data
(63) Continuation of application No. PCT/JP01/00300, filed on Jan. 18, 2001.

(51) Int. Cl. G06F 17/60

(52) U.S. Cl. 705/33

(57) ABSTRACT

The present invention relates to an instantaneous settlement apparatus which settles a purchase of a customer at the spot of the purchase using a debit card and informs the customer of an account balance and an account transaction history.

### TECHNICAL FIELD

The present invention relates to an instantaneous settlement apparatus for settling a purchase of a customer at the spot of the purchase using a debit card which is represented by the Point of Sales Terminal (POS) system or the like.

### BACKGROUND ART

In recent years, the POS system performing settlement of a purchase instantaneously with a bank account using a debit card has been available.

This POS system is a system in which a terminal machine (POS register) is installed in a shop or the like, an operation such as causing the POS register to read information recorded in the debit card instead of payment of cash at the time of payment of a price for a purchase is performed, and settlement is performed by instantaneously transferring an amount equivalent to the purchase price to a bank account of the shop or the like from a bank account of a customer who made the purchase.

In this POS system, a receipt showing how much purchase the customer made (how much amount was transferred from the account of the customer) is given to the customer after the settlement.

However, a receipt which is given to a customer when the customer made a purchase is only a receipt concerning the purchase on which a price or the like of the purchase is printed and is not a receipt on which more information is recorded.

In view of the above-described circumstances, it is an object of the present invention to provide an instantaneous settlement apparatus which can provide useful information to a customer.

### DISCLOSURE OF THE INVENTION

A first instantaneous settlement apparatus among instantaneous settlement apparatuses of the present invention for attaining the above-described object is an instantaneous settlement apparatus, which includes: a card reading section reading information recorded in a debit card owned by a customer and associated with a bank account of the customer; a customer operation section inputting customer authentication information according to an operation of a customer; an amount input section inputting a sales amount; a receipt output section printing to output a receipt showing the sales amount; a communication section performing communication with the outside, settlement of a transaction being performed via the communication section,

characterized in that:

the communication section performing an inquiry of an account balance of the customer to receive account balance information; and

a balance output section outputting an account balance based upon the account balance information received by the communication section.

Here, in the first instantaneous settlement apparatus, a balance inquiry operation section instructing inquiry of an account balance according to an operation is provided, and the communication section preferably performs inquiry of an account balance according to an operation of the balance inquiry operation section.

In this case, the balance inquiry operation section may be operated by a person on a shop side but is preferably provided integrally with the customer operation section and instructs inquiry of an account balance according to an operation of a customer.

In addition, the balance output section may be a display section which is provided integrally with the customer operation section and displays to output an account balance. Alternatively, the receipt output section serves also as the balance output section and the receipt output section prints to output a receipt showing an account balance together with a sales amount.

Here, in the case in which the receipt output section serves also as the balance output section, the receipt output section is preferably provided with a folding mechanism for folding at least an area in which an account balance is shown of a receipt to be outputted. Alternatively, it is also a preferred form of the receipt output section that the receipt output section outputs a receipt on which at least an area where an account balance is shown is covered.

In addition, the first instantaneous settlement apparatus of the present invention is an instantaneous settlement apparatus, which includes: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, may comprise:

a balance inquiry operation section instructing inquiry of an account balance according to an operation; and

the apparatus comprises a balance output section outputting an account balance based upon account balance information obtained by performing inquiry of an account balance.

In the case of this structure, the instantaneous settlement apparatus includes not only a form in which the communication section performs inquiry of an account balance of a customer to receive account balance information and outputs an account balance based upon the account balance information obtained by the receipt as described above but also a form in which the card reading section inquires an account balance from a debit card to obtain account balance information and outputs an account balance based upon the account balance information, a form for outputting a balance, which is found by deducting a payment amount of a purchase of this time from an account balance based upon the account balance information obtained from the debit card, as an account balance, and the like.

In addition, a second instantaneous settlement apparatus among the instantaneous settlement apparatuses of the present invention for attaining the above-described object is an instantaneous settlement apparatus, which includes: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, characterized in that:

the communication section performing an inquiry of an account transaction history of the customer to receive account transaction history information; and

the apparatus comprises a history output section outputting an account transaction history based upon the account transaction history information received by the communication section.

Here, in the second instantaneous settlement apparatus, a history inquiry operation section instructing inquiry of an account transaction history according to an operation is provided, and the communication section preferably performs inquiry of an account transaction history according to an operation of the history inquiry operation section.

In this case, the history inquiry operation section may be operated by a person on a shop side in the same manner as the balance inquiry operation section in the first instantaneous settlement apparatus but is preferably provided integrally with the customer operation section and instructs inquiry of an account transaction history according to an operation of a customer.

In addition, the history output section may be a display section which is provided integrally with the customer operation section and displays to output an account transaction history. Alternatively, the receipt output section serves also as the history output section and the receipt output section prints to output a receipt showing an account transaction history together with a sales amount.

Here, in the case in which the receipt output section serves also as the history output section, the receipt output section is preferably provided with a folding mechanism for folding at least an area in which an account transaction history is shown of a receipt to be outputted. Alternatively, it is also a preferred form of the receipt output section that the receipt output section outputs a receipt on which at least an area where an account transaction history is shown is covered.

In addition, the second instantaneous settlement apparatus of the present invention is an instantaneous settlement apparatus, which includes: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, may comprise:

a history inquiry operation section instructing inquiry of an account transaction history according to an operation; and

a history output section outputting an account transaction history based upon account transaction history information obtained by performing inquiry of an account transaction history.

In the case of this structure, the instantaneous settlement apparatus includes not only a form in which the communication section performs inquiry of an account transaction history of a customer to receive account transaction history information and outputs an account transaction history based upon the account transaction history information obtained by the receipt as described above but also a form in which the card reading section inquires an account transaction history from a debit card to obtain account transaction history information and outputs an account transaction history based upon the account transaction history information, a form for outputting an account transaction history, which is found by adding a payment of a purchase of this time to the account transaction history based upon the account transaction history information obtained from the debit card as a latest account transaction history, and the like.

Conventionally, in an instantaneous settlement system such as the POS system, it is not attempted to obtain information such as balance inquiry and a transaction history. Thus, when a customer wishes to obtain such information, the customer is required to visit a branch of a bank or the like separately from a purchase to perform balance inquiry or make an entry in a bankbook with an automatic teller machine (ATM), a balance inquiry machine, or the like, or perform balance inquiry or the like utilizing a home banking system by a cellular phone or the like.

According to the present invention, a customer can obtain an account balance or a transaction history at the point of settlement of a purchase, whereby convenience for the customer increases significantly.

### BRIEF DESCRIPTION OF THE DRAWINGS

FIG. 1 is a block diagram showing a functional structure of a POS register as an embodiment of an instantaneous settlement apparatus of the present invention;

FIG. 2 is a schematic view showing a structure of a POS system in which the POS register as the embodiment of the instantaneous settlement apparatus of the present invention is adopted;

FIG. 3 is a flowchart showing a flow of selection on whether or not account balance printing or account transaction history printing is required in the POS system shown in FIG. 2;

FIG. 4 shows an example of a purchase receipt on which an account balance is printed;

FIG. 5 shows an example of a purchase receipt on which both of an account balance and an account transaction history are printed;

FIG. 6 is a flowchart showing another example of a flow of selection on whether or not account balance printing or account transaction history printing is required;

FIG. 7 is a schematic view showing a structure of a POS system in which another embodiment of the instantaneous settlement apparatus of the present invention is adopted;

FIG. 8 shows respective part areas of a purchase receipt on which an account balance is printed;

FIG. 9 shows a state in which the purchase receipt shown in FIG. 8 is folded;

FIG. 10 shows a driving mechanism of a folding blade moving in a horizontal direction;

FIG. 11 is a schematic view of a driving mechanism of a folding blade and a cutter blade which move vertically;

FIG. 12 shows each step of a folding operation of a purchase receipt;

FIG. 13 shows each step of a folding operation of the purchase receipt;

FIG. 14 shows each step of a folding operation of the purchase receipt;

FIG. 15 shows each step of a folding operation of the purchase receipt;

FIG. 16 shows each step of a folding operation of the purchase receipt;

FIG. 17 shows each step of a folding operation of the purchase receipt;

FIG. 18 shows each step of a folding operation of the purchase receipt;

FIG. 19 shows each step of a folding operation of the purchase receipt;

FIG. 20 is a schematic view showing another mechanism for realizing folding of a purchase receipt;

FIG. 21 is a perspective view of a rounding member which is employed in the mechanism shown in FIG. 20;

FIG. 22 shows an example of a purchase receipt on which an area in which an account balance and an account transaction history are printed is covered; and

FIG. 23 is an explanatory view of a way of handling the purchase receipt shown in FIG. 22.

### BEST MODE FOR CARRYING OUT THE INVENTION

Embodiments of the present invention will be hereinafter described.

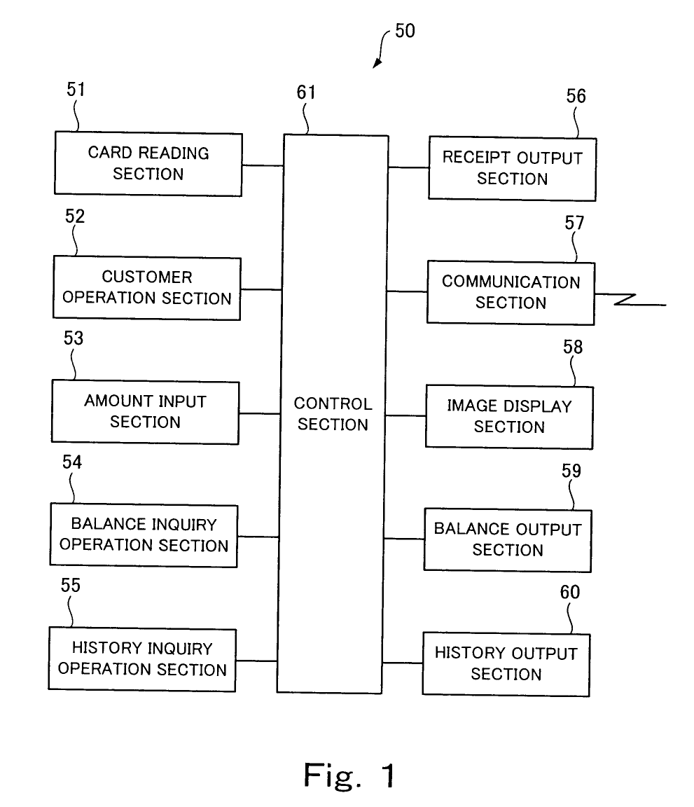

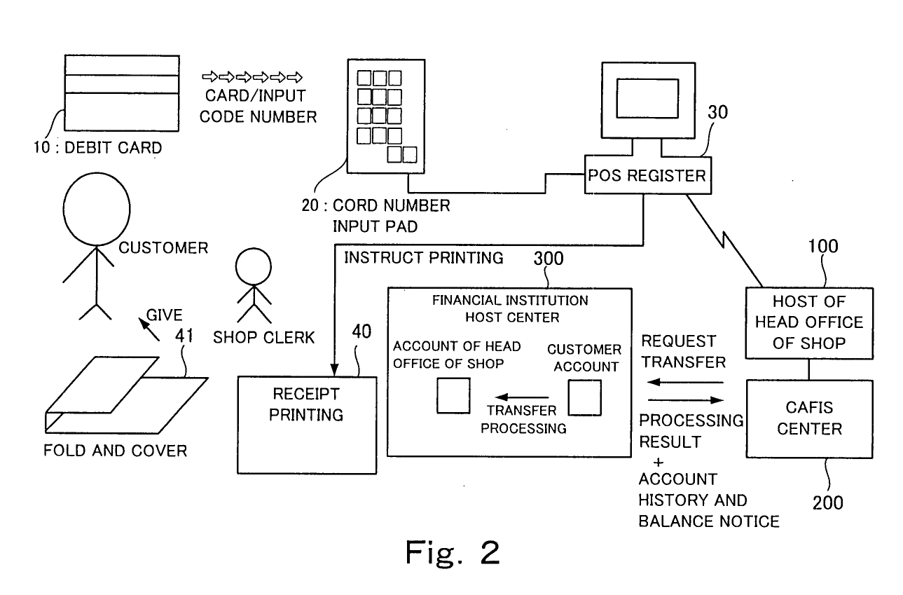

FIG. 1 is a block diagram showing a functional structure of a POS register as an embodiment of an instantaneous settlement apparatus of the present invention. An entire POS system in which this POS register 50 is adopted will be described later with reference to FIG. 2.

The POS register 50 shown in FIG. 1 includes a card reading section 51, a customer operation section 52, an amount input section 53, a balance inquiry operation section 54, a history inquiry operation section 55, a receipt output section 56, a communication section 57, an image display section 58, a balance output section 59, a history output section 60, and a control section 61.

Here, in the card reading section 51, information recorded in a debit card which is owned by a customer and associated with an account of the customer is read.

In addition, in the customer operation section 52, customer authentication information (e.g., a code number) is inputted according to an operation of a customer.

In addition, the amount input section 53 consists of a barcode reader, a keyboard, or the like. In the amount input section 53, a sales amount, types of products, and the like of the customer are inputted.

The balance inquiry operation section 54 and the history inquiry operation section 55 instruct inquiry of an account balance and inquiry of an account transaction history, respectively, according to an operation.

In addition, a receipt showing a sales amount is printed to be outputted in the receipt output section 56.

The communication section 57 performs communication with the outside. In the POS register 50, settlement of a transaction is performed via the communication section 57. In addition, in this communication section 57, inquiry of an account balance or an account transaction history is performed according to an operation of the balance inquiry operation section 54 or the history inquiry operation section 55, and account balance information or account transaction history information is received.

In addition, information necessary for this transaction is displayed on the screen display section 58.

In the balance output section 59 and the history output section 60, the account balance based upon the account balance information and the account transaction history based upon the account transaction history information, which are received by the communication section 57, are outputted, respectively.

Further, the control section 61 administers overall control of the POS register 50.

Here, in the case of the system shown in FIG. 2, the balance inquiry operation section 54 and the history inquiry operation section 55 are provided integrally with the customer operation section 52 (code number input pad 20 shown in FIG. 2) and instruct inquiry of an account balance and inquiry of an account transaction history, respectively, according to an operation of a customer.

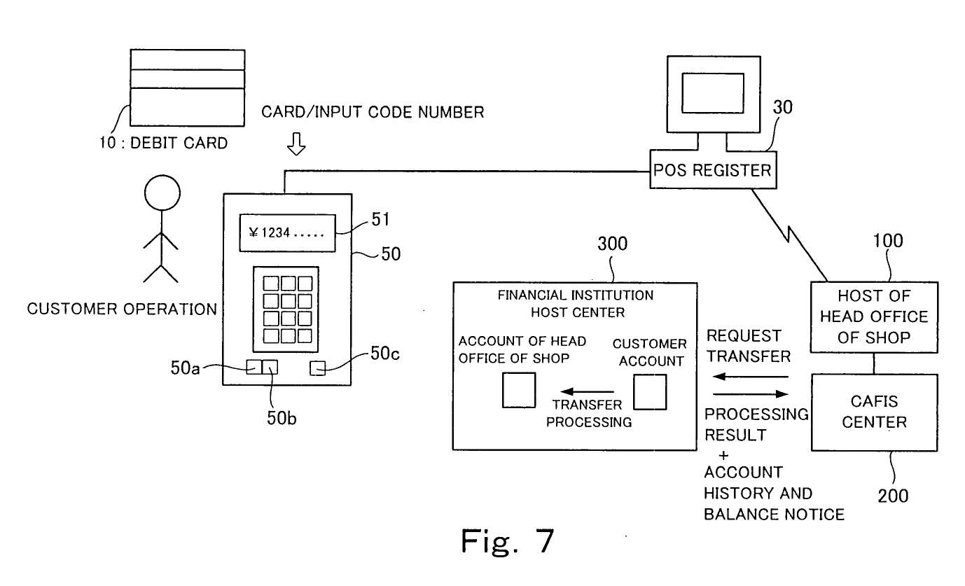

In addition, the balance output section 59 and the history output section 60 may be a display section which is provided integrally with the customer operation section 52 and displays to output an account balance and an account transaction history (the system shown in FIG. 7 is equivalent to this). Alternatively, the receipt output section 56 may serve also as both the balance output section 59 and the history output section 60 and print to output a receipt showing an account balance and an account transaction history together with a sales amount (the system shown in FIG. 2 is equivalent to this).

Here, in the case in which the receipt output section 56 serves also as both the balance output section 59 and the history output section 60, the receipt output section 56 is preferably provided with a folding mechanism for folding at least an area in which an account balance and an account transaction history are shown of a receipt to be output.

FIG. 2 is a schematic view showing a structure of a POS system in which the POS register as the embodiment of the instantaneous settlement apparatus of the present invention is adopted.

A customer, who has made a purchase at a certain shop and intends to pay a price for the purchase utilizing a debit card 10 owned by himself/herself, informs a shop clerk to that effect and uses a code number input pad 20 of a POS register 30 (an example of the instantaneous settlement apparatus in the present invention) installed in the shop to cause the POS register 30 to read information recorded in the debit card 10 and, at the same time, input a code number (an example of customer authentication information in the present invention). At that point, the customer presses an account balance print button 20a when the customer wishes to know a balance of his/her own account and presses an account transaction history print button 20b when the customer wishes to know a transaction history of his/her own account.

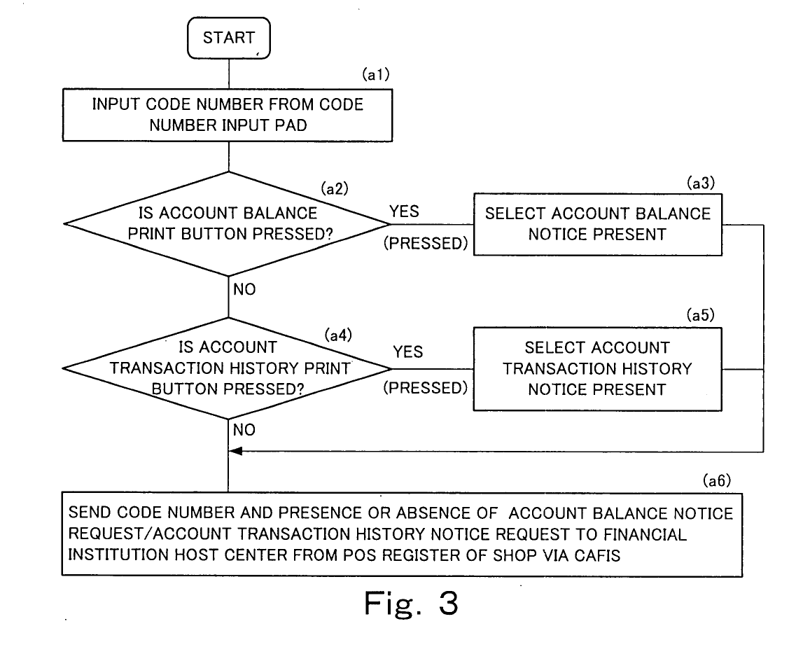

FIG. 3 is a flowchart showing a flow of selection on whether or not account balance printing or account transaction history printing is required in the POS system shown in FIG. 2.

The customer inputs his/her own code number using the code number input pad 10 (step a1). In addition, it is judged whether or not the account balance print button 20a has been pressed (step a2) and, when the account balance print button 20a has been pressed, “account balance notice is present” is selected (step a3). Further, it is judged whether or not the account transaction history print button 20b has been pressed (step s4) and, when the account transaction history print button 20b has been pressed, “account transaction history notice is present” is selected (step a5). The code number inputted from the code number input pad 20 and the presence or absence of an account balance notice request or an account transaction notice request are sent to a financial institution host center 300 from the POS register 30 of a shop at which the customer made a purchase via a CAFIS center 200 (step a6).

Referring back to FIG. 1, the description will be continued.

A price or the like of the purchase is also inputted in the POS register 30 shown in FIG. 1. When such an input ends, the POS register 30 sends the data to a host computer 100 of a head office of the shop, and the host computer 100 of the head office informs the CAFIS center 200, which is a settlement contract institution, of the data. The CAFIS center 200 communicates with the financial institution host center 300 and requests it to transfer an amount equivalent to the price of the purchase to an account of the head office of the shop from an account of the customer. In the case in which the account balance print button 20a or the account transaction history print button 20b of the code number input pad 20 is pressed by the customer, the CAFIS center 200 requests it to inform the customer of an account balance or an account transaction history.

The financial institution host center 300 transfers the amount equivalent to the transaction (purchase) of this time to the account of the head office of the shop from the account of the customer according to the request from the CAFIS center 200 and informs the CAFIS center 200 of a balance of the account or a transaction history of the customer after the transfer of this time together with a result of the transfer processing according to a balance notice request or a transaction history notice request. The result of the transfer processing, and the account balance and the account transaction history are sent to the POS register 30 of the shop via the host computer 100 of the head office of the shop. When a result of processing indicating that the transfer was not performed correctly due to an insufficient balance or the like is sent to the POS system 30 of the shop, the transaction is not concluded.

On the other hand, when the result of the transfer processing indicates that the transfer was performed correctly, the transaction is concluded, and information concerning the transaction of this time is printed out from a receipt printer 40 connected to the POS register 30. When the customer has pressed the account balance print button 20a or the account transaction history print button 20b of the code number input pad 20 in advance, a purchase receipt 41 on which information concerning an account balance or a transaction history is printed is printed out. The purchase receipt 41 is folded to be outputted from the receipt printer 40 as described later such that the account balance or the account transaction history are not easily known by shop clerks and people around the receipt printer 40.

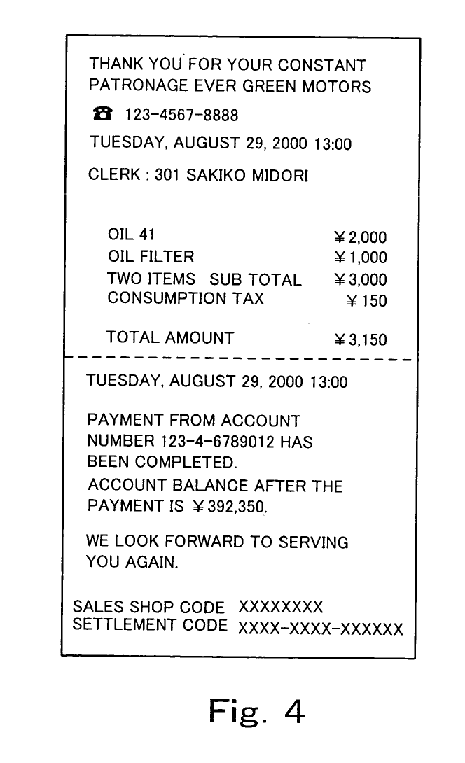

FIG. 4 shows an example of a purchase receipt on which an account balance is printed.

Here, information on a transaction (purchase) of this time is printed in an upper half of the purchase receipt and the account balance and the like are printed on a lower half thereof.

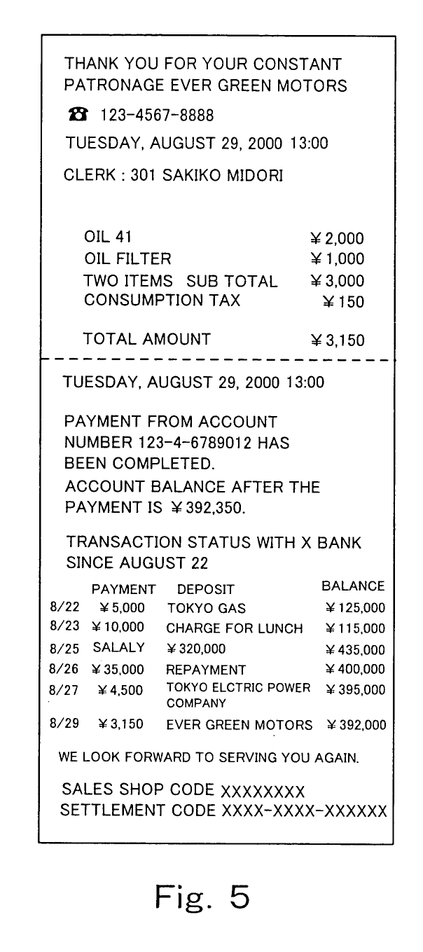

FIG. 5 shows an example of a purchase receipt on which both of an account balance and an account transaction history are printed. Here, information on a transaction (purchase) of this time is printed in an upper half of the purchase receipt and both the account balance and the account transaction history are printed on a lower half thereof.

Folding of the purchase receipt, the examples of which are shown in FIGS. 4 and 5, will be described later.

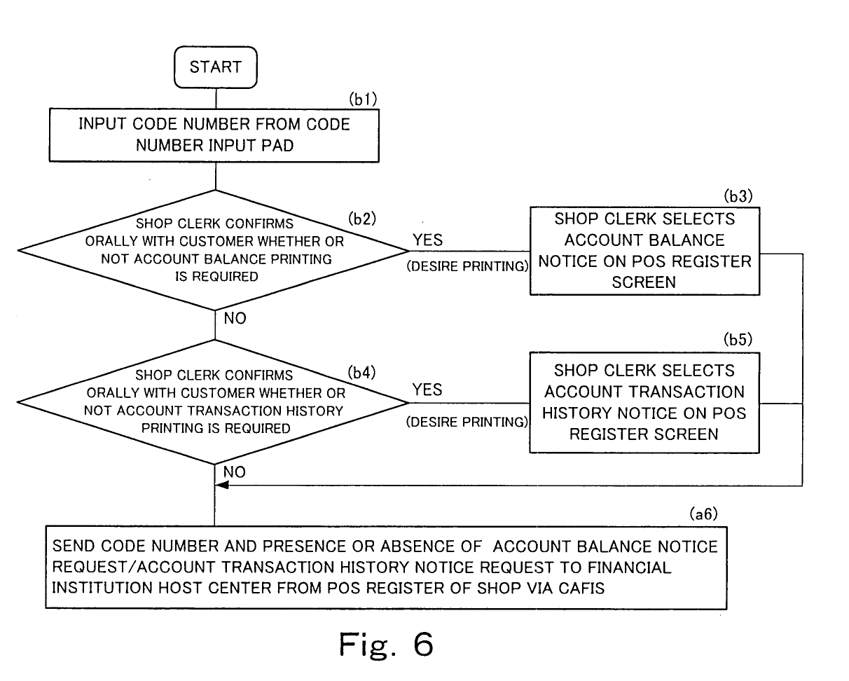

FIG. 6 is a flowchart showing another example of a flow of selection on whether or not account balance printing or account transaction history printing is required.

In the POS register 30 of the POS system shown in FIG. 2, the code number input pad 20 is provided with the account balance print button 20a and the account transaction history print button 20b, and presence or absence of an account balance notice request or an account transaction history notice request is recognized according to whether or not the buttons are pressed by a customer. However, instead of this, as shown in FIG. 6, the POS register 30 may be adapted such that a shop clerk asks a request of a customer and inputs the request.

In this case, a code number is inputted from the code number input pad 20 by the customer (step b1). Thereafter, the shop clerk confirms orally with the customer whether or not account balance printing is required (step b2). When the customer desires printing of an account balance, the shop clerk selects an account balance notice on a screen of the POS register 30 (step b3). In addition, the shop clerk confirms orally with the customer whether or not account transaction history printing is required (step b4). When the customer desires the account transaction history printing, the shop clerk selects an account balance notice on the screen of the POS register 30 (step b5). When such an operation is performed, the code number and presence or absence of the account balance notice request or the account transaction history notice request, which are inputted from the code number input pad 20, are sent to the financial institution host center 300 from the POS register 30 of the shop via the CAFIS center 200 (step b6).

Here, in the above-described embodiment, when the account balance print button 20a is pressed or the account transaction history print button 20b is pressed, communications with the outside to perform inquiry of an account balance or an account transaction history is performed, and printing of the account balance or the account transaction history based upon account balance information or account transaction history information obtained by the communication is performed. Instead of this, in response to pressing of the account balance print button 20a or the account transaction history button 20b, account balance information or account transaction history information may be received from a debit card, and an account balance or an account transaction history based upon the account balance information or the account transaction history information may be printed. Moreover, an amount found by deducting a payment price of a purchase of this time from the account balance based upon the account balance information received from the debit card may be printed as an account balance, or the payment of the purchase of this time may be added to the account transaction history based upon the account transaction history information received from the debit card as a latest account transaction history to print the account transaction history.

FIG. 7 is a schematic view showing a structure of a POS system in which another embodiment of the instantaneous settlement apparatus of the present invention is adopted.

Differences between this POS system and the POS system shown in FIG. 2 will be described.

In FIG. 7, a code number input pad 50 equivalent to the code number input pad 20 shown in FIG. 2 is shown. The code number input pad 50 is provided with a display section 51 displaying an account balance and an account transaction history of a customer and is further provided with an account balance print button 50a and an account transaction history print button 50b, which are equivalent to the account balance print button 20a and the account transaction history print button 20b which are provided in the code number input pad 20 shown in FIG. 2, respectively. In addition, the code number input pad 50 is provided with a display erase button 50c for erasing a display on the display section 51.

In FIG. 7, a receipt printer equivalent to the receipt printer 40 shown in FIG. 2 is not shown. An illustration of a receipt printer is omitted because the receipt printer is not characteristic in the embodiment of FIG. 7 but outputs an ordinary purchase receipt consisting only of the upper half part of FIG. 4 or FIG. 5.

A customer inputs a code number using the code number input pad 50, and the account balance print button 50a or the account transaction history print button 50b is pressed according to a desire of the customer.

Account balance information and account transaction history information obtained by the account balance print button 50a and the account transaction history print button 50b are printed on a purchase receipt together as illustrated in FIG. 4 or FIG. 5 in the system shown in FIG. 2. In the system shown in FIG. 7, the information is displayed on the display section 51 of the code number input pad 50 instead of printing of the account balance or the account transaction history on the purchase receipt. In this case, after the customer confirms the display, the customer himself/herself can immediately erase the display by pressing the display erase button 50c and it is possible to prevent others from seeing the display. In addition, even if the display erase button 50c is not pressed, the display is erased after a fixed time. Further, although not shown in FIG. 7, in order to reduce the likelihood of being seen by others while the customer himself/herself confirms the display of the display section 51, it is preferable to attach a cover for shielding a view from directions other than a view of the customer.

Next, returning to the description of the system shown in FIG. 2, a folding mechanism of a receipt with the receipt printer 40 will be described.

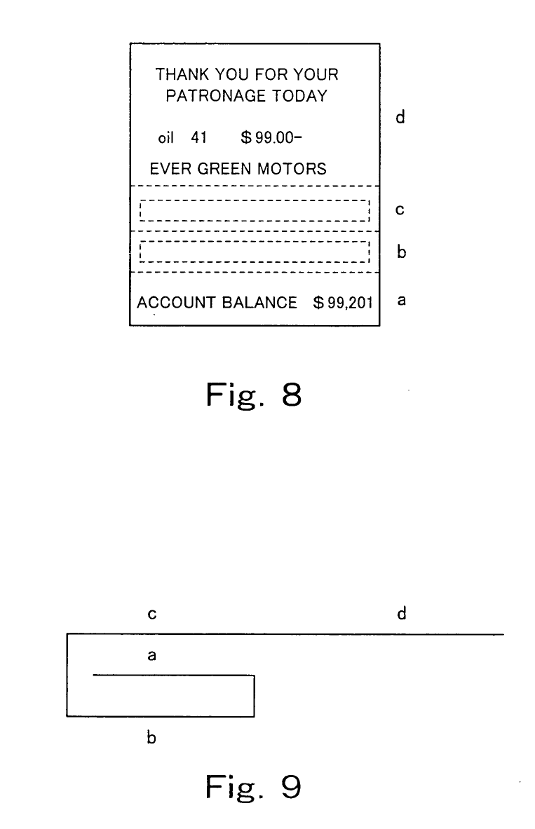

FIG. 8 shows each part area of a purchase receipt on which an account balance is printed. FIG. 9 shows a state in which the purchase receipt shown in FIG. 8 is folded.

Here, the purchase receipt shown in FIG. 8 is folded in a shape in which an area “a” on which the account balance is printed is sandwiched by an area “b” and an area “c” as shown in FIG. 9.

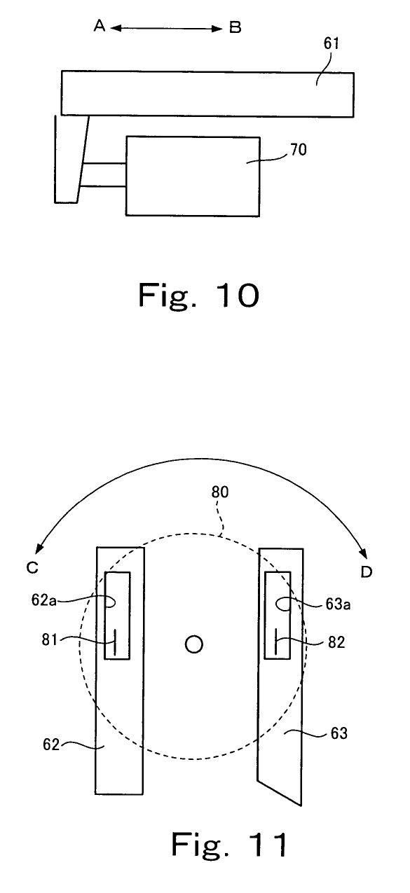

FIG. 10 shows a driving mechanism of a folding blade 61 moving in a horizontal direction which constitutes a receipt folding mechanism described below. FIG. 11 shows a driving mechanism of a folding blade 62 and a cutter blade 63, which move vertically, of the receipt folding mechanism described below.

As shown in FIG. 10, the folding blade 61 moves in the horizontal direction and is driven according to ON/OFF of a plunger 70 in an arrow A direction and an arrow B direction.

In addition, as shown in FIG. 11, the folding blade 62 and the cutter blade 63 moving vertically have oblong slits 62a and 63a, respectively. Bosses 81 and 82 provided in a gear 80 rotating in an arrow C-D direction are loosely inserted in the slits 62a 63a, respectively. Here, when the gear 80 rotates in the arrow C direction, the folding blade 62 falls due to interference between the boss 81 and the slit 62a. When the gear 80 rotates in the arrow D direction, the cutter blade 63 falls due to interference between the boss 82 and the slit 63a. When the gear 80 is in a neutral position between the rotation in the arrow C direction and the rotation in the arrow D direction, both the folding blade 62 and the cutter blade 63 are in an risen position.

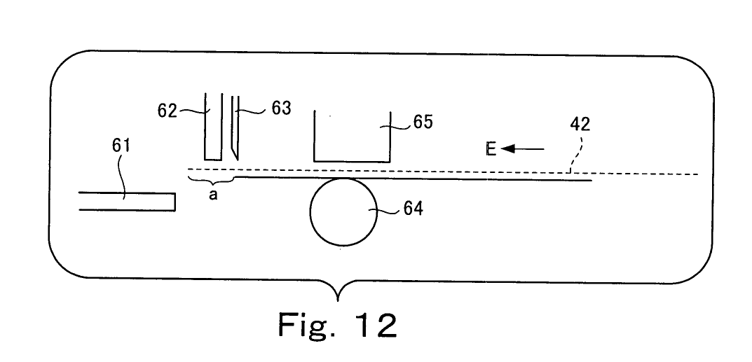

FIGS. 12 to 19 show each step of an folding operation of a purchase receipt.

As shown in FIG. 12, a sheet 42 to be outputted as a purchase receipt is conveyed in an arrow E direction, and predetermined information is printed by a print head 65 on a platen 64.

In the print head 65, first, printing of the area “a” of the receipt of FIG. 8 is performed. Thereafter, skipping the areas “b” and “c” (or printing of black or shading is performed such that the print of the area “a” is not seen through), printing of the area “d” is further performed.

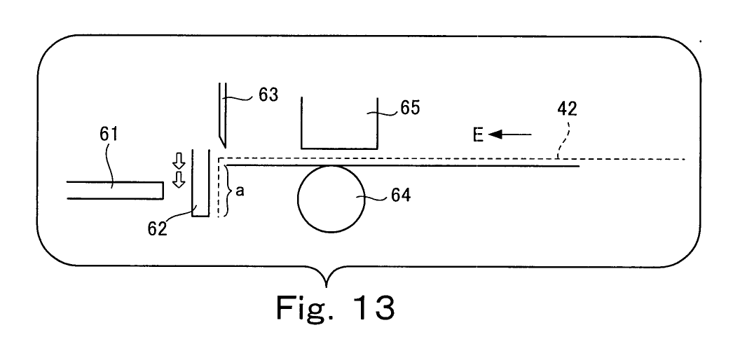

First, in a state in which only the part of the area “a” is delivered to a position shown in FIG. 12, the folding blade 62 falls to bend the area “a” by 90° as shown in FIG. 13.

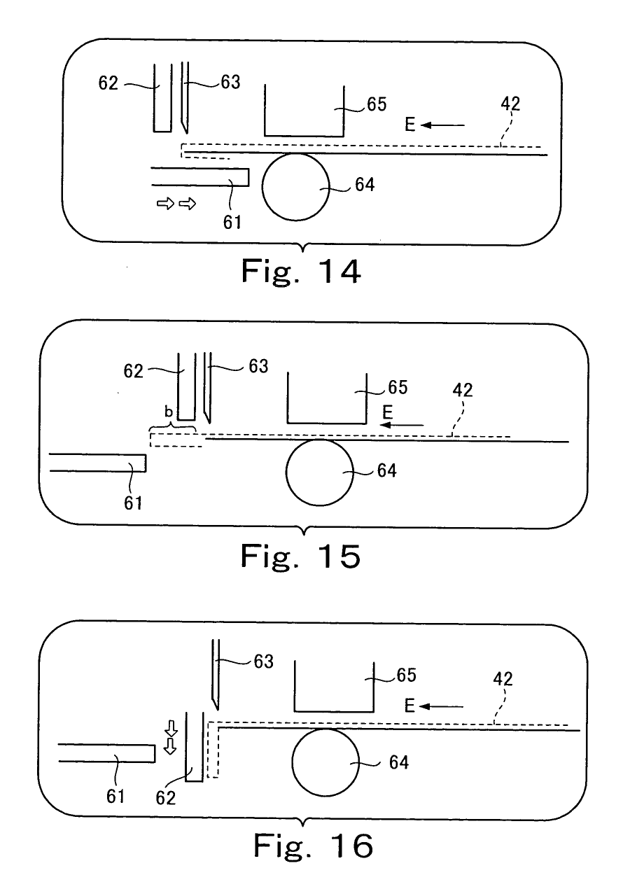

Next, as shown in FIG. 14, the folding blade 62 rises and the folding blade 61 moves forward to fold the area “a” by 90° further.

Next, as shown in FIG. 15, the folding blade 61 moves backward and, at the same time, the sheet 42 moves in an arrow E direction until the part of the area b is delivered to an illustrated position. Then, as shown in FIG. 16, the folding blade 62 falls to bend the area “a” by 90°.

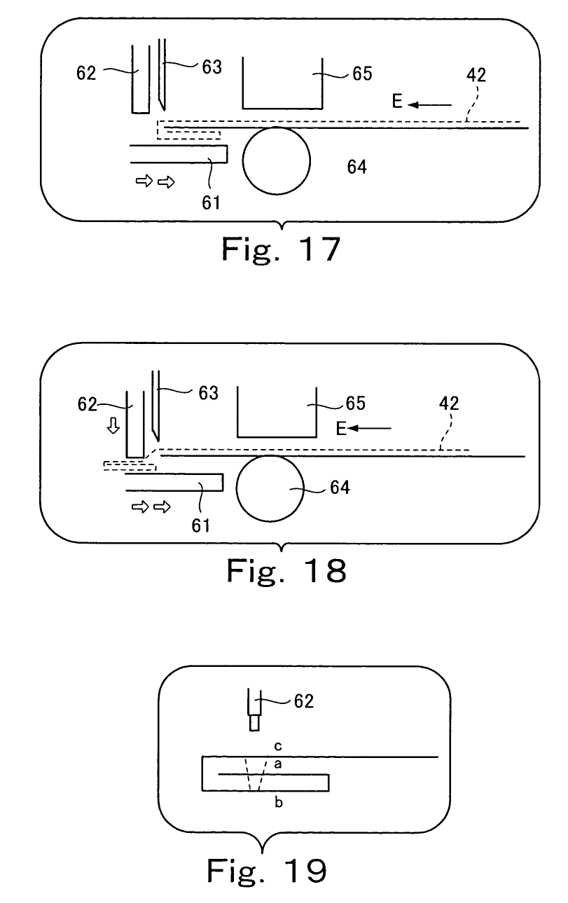

Moreover, as shown in FIG. 17, the folding blade 62 rises and the folding blade 61 moves forward to fold the area “b” by 90° further. While this state is kept, the part of the area “c” is delivered and the folding blade 62 falls as shown in FIG. 18. A tip of the folding blade 62 has a blade of a paper clip, and when the folding blade 62 falls, the areas “a”, “b”, and “c” which are folded with the folding blade 61 under them as a base are paper-clipped each other.

FIG. 19 is an explanatory view of an operation of the paper clip.

The paper clip operation is an operation for pushing a part of paper (receipt) with a force enough for deforming the sheet and clipping the areas “a”, “b”, and “c” each other according to the deformation. Since this paper clip itself is publicly known, more detailed descriptions of the paper clip will be omitted.

After the paper clip operation is performed as shown in FIG. 18, the folding blade 62 rises, the sheet 42 is delivered to the area “d”, and the sheet 42 is cut by the fall of the cutter blade 63, whereby the area “a” in which the account balance is printed is folded and a purchase receipt in a paper-clipped state is outputted.

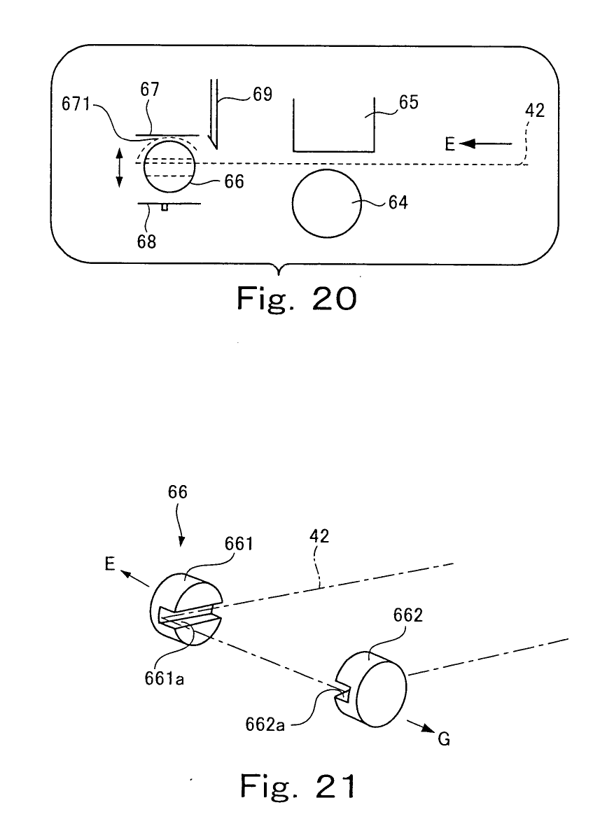

FIG. 20 is a schematic view showing another mechanism for outputting a purchase receipt in a folded state. FIG. 21 is a perspective view of a rounding member which is employed in the mechanism shown in FIG. 20.

The receipt sheet 42 is delivered in the arrow E direction, necessary information including information which only a customer is informed of as an account balance is printed thereon by the print head 65 on the platen 64, and it is further delivered.

As shown in FIG. 21, the receipt rounding member 66 consists of two members 661 and 662 provided in positions corresponding to both sides of the receipt sheet 42. In the respective members 661 and 662, slits 661a and 662a for nipping both the sides of the delivered receipt sheet are formed. As shown in FIG. 21, when both side edges of a trailing edge portion of the receipt sheet 42 are nipped by the slits 661a and 662a, the rounding member 66 rotates keeping pace with the subsequent delivery of the receipt sheet to wind the receipt sheet around it. When the winding to an appropriate position ends, the two members 661 and 662 constituting the receipt rounding member 66 moves in a direction parting from the receipt sheet 42, that is, a direction of arrows F and G, respectively, whereby both the side edges of the receipt sheet 42 are released from the slits 661a and 662a and, at the same time, crushing members 67 and 68 fall and rise, respectively, to crush the receipt sheet 42 in the rounded shape. In doing so, the crushing member 67 on the upper side is provided with a paper clip member 671 and a paper clip operation is performed with the crushing member 68 on the lower side as a base.

Thereafter, at a stage in which the receipt sheet 42 is delivered to an appropriate position, the cutter blade 69 falls to cut the receipt sheet 42, whereby a purchase receipt in a state in which a part of it is folded is completed.

A folded purchase receipt can also be prepared by such a mechanism described with reference to FIGS. 20 and 21.

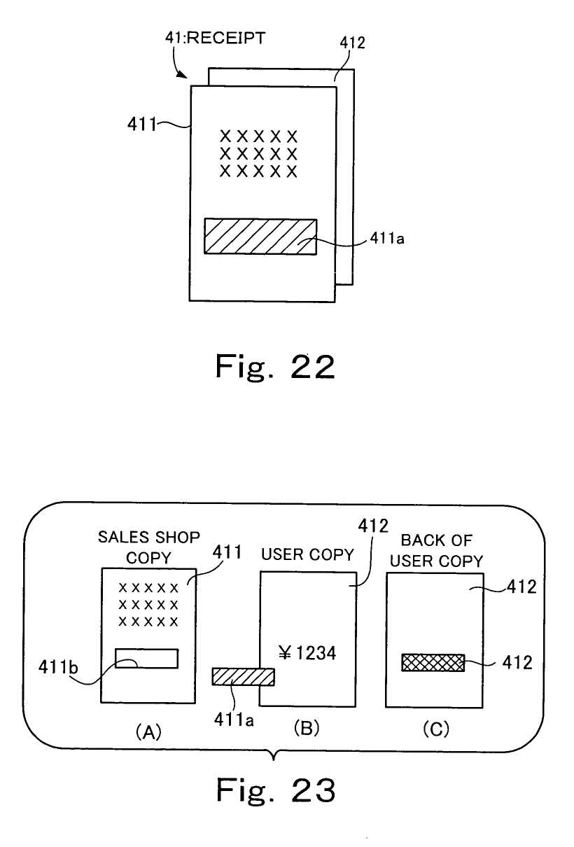

FIG. 22 shows an example of a purchase receipt on which an area in which an account balance and an account transaction history are printed is covered. FIG. 22 is an explanatory view of a way of handling the purchase receipt shown in FIG. 21.

The purchase receipt 41 consists of thermal paper and includes two sheets of a sales shop copy 411 and a user copy 412. In order to cope with the purchase receipt 41, a thermal printer for applying printing to thermal paper is used as a receipt printer (see FIG. 2).

A thermal material is not originally applied to an area 411a, in which an account balance and an account transaction history are printed, of the sales shop copy 411 of the purchase receipt 41. Thick color print is applied to the area instead. Therefore, information printed on that part by the thermal printer is not printed on the sales shop copy 411 but printed on the user copy 412 only.

The area 411a of the sales shop copy 411 is adhered to the user copy 412 to a level allowing it to be peeled off with a certain degree of force. In addition, perforation is formed around the area 411a, and when the sales shop copy 411 is peeled off from the user copy 412, as shown in FIG. 23, the area 411a is left on the user copy 412, and an opening 411b is formed in the part of the area 411a on the sales shop copy 411. A user (customer) having received the user copy 412 can confirm his/her own account balance by peeling off a slip of paper covering an account balance and the like of the user copy 412.

Note that, in an area 412a in which an account balance and the like are printed on both sides of the user copy 412, printing for preventing it being seen through from its back is applied.

In this way, an area in which an account balance and an account transaction history are printed is prevented from being seen by shop clerks and others.

Note that, although the above-described embodiment is an example in which a customer is informed of both of an account balance and an account transaction history according to a desire of the customer, the present invention is not limited to this and one of the account balance and the account transaction history may be informed.

In addition, although the above-described embodiment is an example in which a customer is informed of an account balance and an account transaction history only when the customer wishes so, a service for informing a customer of the account balance and the account transaction history uniformly without specifically confirming a desire of the customer may be performed.

1. An instantaneous settlement apparatus having: a card reading section reading information recorded in a debit card owned by a customer and associated with a bank account of the customer; a customer operation section inputting customer authentication information according to an operation of a customer; an amount input section inputting a sales amount; a receipt output section printing to output a receipt showing the sales amount; and a communication section performing communication with the outside, settlement of a transaction being performed via the communication section, characterized in that:
the communication section performs an inquiry of an account balance of the customer to receive account balance information; and
the apparatus comprises a balance output section outputting an account balance based upon the account balance information received by the communication section.

2. The instantaneous settlement apparatus according to claim 1, characterized in that the apparatus further comprises a balance inquiry operation section instructing inquiry of an account balance according to an operation is provided, and
the communication section performs inquiry of an account balance according to an operation of the balance inquiry operation section.

3. The instantaneous settlement apparatus according to claim 2, characterized in that the balance inquiry operation section is provided integrally with the customer operation section and instructs inquiry of an account balance according to an operation of a customer.

4. The instantaneous settlement apparatus according to claim 1, characterized in that the balance output section is a display section which is provided integrally with the customer operation section and displays to output an account balance.

5. The instantaneous settlement apparatus according to claim 1, characterized in that the receipt output section serves also as the balance output section and the receipt output section prints to output a receipt showing an account balance together with a sales amount.

6. The instantaneous settlement apparatus according to claim 5, characterized in that the receipt output section is provided with a folding mechanism for folding at least an area in which an account balance is shown of a receipt to be outputted.

7. The instantaneous settlement apparatus according to claim 5, characterized in that the receipt output section outputs a receipt on which at least an area where an account balance is shown is covered.

8. An instantaneous settlement apparatus having: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, characterized by comprising:
a balance inquiry operation section instructing inquiry of an account balance according to an operation; and
a balance output section outputting an account balance based upon account balance information obtained by performing inquiry of an account balance.

9. An instantaneous settlement apparatus having: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, characterized in that:
the communication section performs an inquiry of an account transaction history of the customer to receive account transaction history information; and
the apparatus comprises a history output section outputting an account transaction history based upon the account transaction history information received by the communication section.

10. The instantaneous settlement apparatus according to claim 9, characterized in that the apparatus further comprises a history inquiry operation section instructing inquiry of an account transaction history according to an operation, and
the communication section performs inquiry of an account transaction history according to an operation of the history inquiry operation section.

11. The instantaneous settlement apparatus according to claim 10, characterized in that the history inquiry operation section is provided integrally with the history operation section and instructs inquiry of an account balance according to an operation of a customer.

12. The instantaneous settlement apparatus according to claim 9, characterized in that the history output section is a display section which is provided integrally with the customer operation section and displays to output an account transaction history.

13. The instantaneous settlement apparatus according to claim 9, characterized in that the receipt output section serves also as the history output section and the receipt output section prints to output a receipt showing an account transaction history together with a sales amount.

14. The instantaneous settlement apparatus according to claim 13, characterized in that the receipt output section is provided with a folding mechanism for folding at least an area in which an account transaction history is shown of a receipt to be outputted.

15. The instantaneous settlement apparatus according to claim 13, characterized in that the receipt output section outputs a receipt on which at least an area where an account transaction history is shown is covered.

16. An instantaneous settlement apparatus having: a card reading section reading information recorded in a debit card owned by a customer and associated with a bank account of the customer; a customer operation section inputting customer authentication information according to an operation of the customer; an amount input section inputting a sales amount; a receipt output section printing to output a receipt showing the sales amount; and a communication section performing communication with the outside, settlement of a transaction being performed via the communication section, characterized by comprising:
a history inquiry operation section instructing inquiry of an account transaction history according to an operation; and
a history output section outputting an account transaction history based upon account transaction history information obtained by performing inquiry of an account transaction history.
